(19) United States
(12) Patent Application Publication
(10) Pub. No.: US 2012/0146995 A1
(43) Pub. Date: Jun. 14, 2012

(54) STEREOSCOPIC IMAGE DISPLAY AND METHOD FOR DRIVING THE SAME

(76) Inventors: Jeongki LEE, Gyeonggi-do (KR); Hyeonho SON, Gyeonggi-do (KR); Juhoon JANG, Seoul (KR)

(21) Appl. No.: 13/111,382

(22) Filed: May 19, 2011

(30) Foreign Application Priority Data
Dec. 9, 2010 (KR) 10-2010-0125622

(51) Int. Cl. G06T 15/00

(52) U.S. Cl. 345/419

(57) ABSTRACT

A stereoscopic image display and a method for driving the same are discussed. The stereoscopic image display includes a display panel including data lines and gate lines crossing the data lines, a data modulation unit, that modulates input image data so that pixel data of an nth line of the image data approaches a black gray level as pixel data of an (n−1)th line of the image data approaches a white gray level, where n is a natural number equal to or greater than 2, a data driver, that converts the image data modulated by the data modulation unit into a data voltage and outputs the data voltage to the data lines, and a gate driver sequentially outputting a gate pulse synchronized with the data voltage to the gate lines.

This application claims the benefit of Korean Patent Application No. 10-2010-0125622 filed on Dec. 9, 2010, the entire contents of which is incorporated herein by reference for all purposes as if fully set forth herein.

### BACKGROUND OF THE INVENTION

1. Field of the Invention

Embodiments of the invention relate to a patterned retarder type stereoscopic image display and a method for driving the same.

2. Discussion of the Related Art

A stereoscopic image display is classified into a display using a stereoscopic technique and a display using an autostereoscopic technique. The stereoscopic technique, which uses a parallax image between left and right eyes of a user with a high stereoscopic effect, includes a glasses type method and a non-glasses type method, both of which have been put on the market. In the glasses type method, the parallax image between the left and right eyes is displayed on a direct-view display or a projector through a change in a polarization direction of the left and right parallax image or in a time-division manner, and thus a stereoscopic image is implemented using polarization glasses or shutter glasses. In the non-glasses type method, an optical axis of the parallax image between the left and right eyes is generally separated using an optical plate such as a parallax barrier and a lenticular lens, and thus the stereoscopic image is implemented.

FIG. 1 illustrates a related art patterned retarder type stereoscopic image display. As shown in FIG. 1, the patterned retarder type stereoscopic image display implements a stereoscopic image using polarization characteristic of a patterned retarder PR disposed on a display panel DIS and polarization characteristic of polarization glasses PG a user wears. The patterned retarder type stereoscopic image display displays a left eye image on odd-numbered lines of the display panel DIS and displays a right eye image on even-numbered lines of the display panel DIS. The left eye image of the display panel DIS passes through the patterned retarder PR and is converted into a left eye polarization. Further, the right eye image of the display panel DIS passes through the patterned retarder PR and is converted into a right eye polarization. A left eye polarization filter of the polarization glasses PG passes through only the left eye polarization, and a right eye polarization filter of the polarization glasses PG passes through only the right eye polarization. Thus, the user views only the left eye image through his or her left eye and views only the right eye image through his or her right eye.

FIG. 2 is a table illustrating a luminance of the related art patterned retarder type stereoscopic image display shown in FIG. 1. As shown in FIG. 2, a luminance of the left eye image input to the left eye polarization filter of the polarization glasses PG was measured by supplying left eye image data RGB_{L} having a white gray level G255 and supplying right eye image data RGB_{R} having the white gray level G255, grey gray levels G191, G127, and G63,and a black gray level G0.

Because the left eye polarization filter of the polarization glasses PG passes through only the left eye image, the luminance of the left eye image passing through the left eye polarization filter of the polarization glasses PG has to be uniform irrespective of the right eye image. However, as shown in FIG. 2, the luminance of the left eye image passing through the left eye polarization filter of the polarization glasses PG increases as a gray level of the right eye image data RGB_{R} increases. In other words, the luminance of the left eye image passing through the left eye polarization filter of the polarization glasses PG is affected by the gray level of the right eye image. Hence, a three-dimensional (3D) crosstalk, in which the user may see doubled images by leaking part of the left eye image into the right eye image and vice versa, is generated in the related art. The 3D crosstalk may cause the user inconvenience when the user views the stereoscopic image.

### SUMMARY OF THE INVENTION

In one aspect, there is a stereoscopic image display including a display panel including data lines and gate lines crossing the data lines, a data modulation unit configured to modulate input image data so that pixel data of an nth line of the image data approaches a black gray level as pixel data of an (n−1)th line of the image data approaches a white gray level, where n is a natural number equal to or greater than 2, a data driver configured to convert the image data modulated by the data modulation unit into a data voltage and output the data voltage to the data lines, and a gate driver configured to sequentially output a gate pulse synchronized with the data voltage to the gate lines.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates a related art patterned retarder type stereoscopic image display;

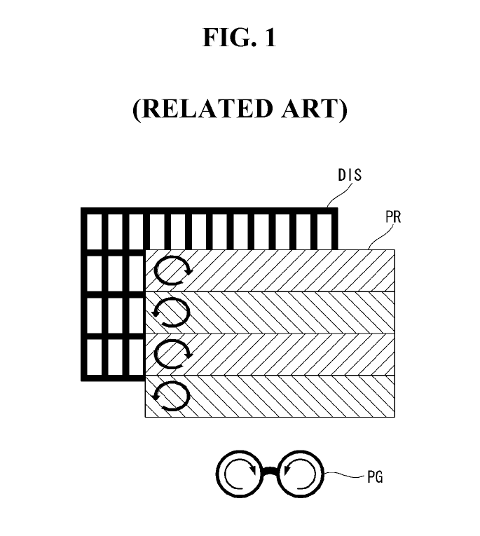

FIG. 2 is a table illustrating a luminance of a related art patterned retarder type stereoscopic image display;

FIG. 3 is a block diagram schematically illustrating a stereoscopic image display according to an example embodiment of the invention;

FIG. 4 is an exploded perspective view illustrating a display panel, a patterned retarder, and polarization glasses;

FIG. 5 is a block diagram illustrating a first exemplary configuration of a data modulation unit;

FIG. 6 illustrates an exemplary lookup table shown in FIG. 5;

FIG. 7 is a block diagram illustrating a second exemplary configuration of a data modulation unit;

FIG. 8 illustrates an exemplary lookup table shown in FIG. 7;

FIG. 9 is a table illustrating a luminance of a patterned retarder type stereoscopic image display according to an example embodiment of the invention; and

FIG. 10 is a flow chart sequentially illustrating a method for driving a stereoscopic image display according to an example embodiment of the invention.

### DETAILED DESCRIPTION OF THE EMBODIMENTS

The invention will be described more fully hereinafter with reference to the accompanying drawings, in which example embodiments of the inventions are shown. This invention may, however, be embodied in many different forms and should not be construed as limited to the embodiments set forth herein. Like reference numerals designate like elements throughout the specification. In the following description, if it is decided that the detailed description of known function or configuration related to the invention makes the subject matter of the invention unclear, the detailed description is omitted.

Names of elements used in the following description may be selected in consideration of facility of specification preparation. Thus, the names of the elements may be different from names of elements used in a real product.

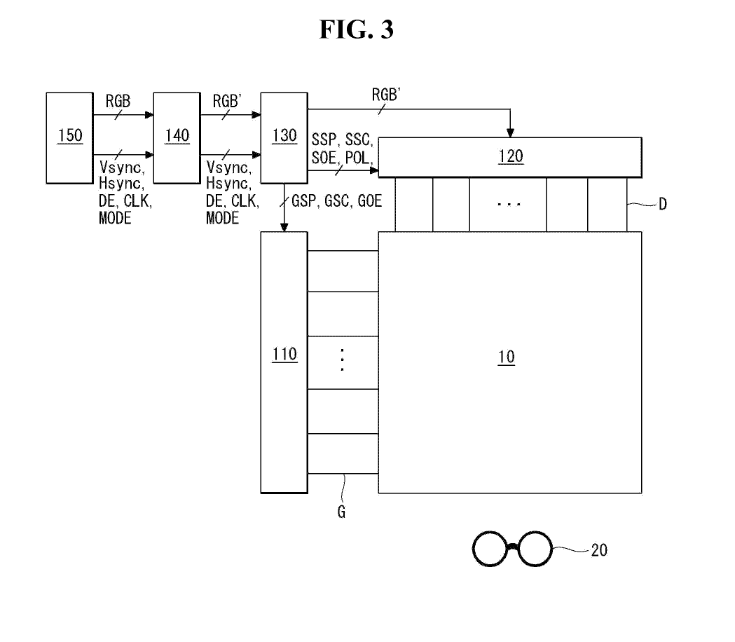

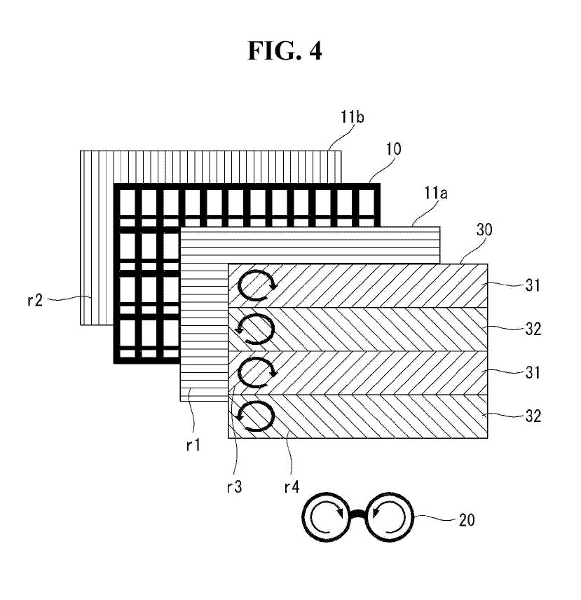

FIG. 3 is a block diagram schematically illustrating a stereoscopic image display according to an example embodiment of the invention. FIG. 4 is an exploded perspective view illustrating a display panel, a patterned retarder, and polarization glasses. The stereoscopic image display according to the embodiment of the invention may be implemented as a flat panel display device such as a liquid crystal display (LCD), a field emission display (FED), a plasma display panel (PDP), and an electroluminescence device (EL) including an organic light emitting diode (OLED) element. Hereinafter, the stereoscopic image display according to the embodiment of the invention is described using the liquid crystal display as an example. Other types of display devices may be used.

As shown in FIGS. 3 and 4, the stereoscopic image display according to the embodiment of the invention includes a display panel 10, polarization glasses 20, a gate driver 110, a data driver 120, a timing controller 130, a data modulation unit 140, a host system 150, and the like. The display panel 10 displays an image under the control of the timing controller 130. The display panel 10 includes a thin film transistor (TFT) substrate and a color filter substrate. A liquid crystal layer is formed between the TFT substrate and the color filter substrate.

Data lines D and gate lines (or scan lines) G are formed on the TFT substrate to cross each other, and a plurality of liquid crystal cells are arranged in a plurality of cell regions defined by the data lines D and the gate lines G in a matrix form. TFTs formed at crossings between the data lines D and the gate lines G transfer a data voltage supplied through the data lines D to pixel electrodes of the liquid crystal cells in response to a gate pulse from the gate lines G. For the above-described operation, in each of the TFTs, a gate electrode is connected to the gate line G, a source electrode is connected to the data line D, and a drain electrode is connected to the pixel electrode of the liquid crystal cell and a storage capacitor. The storage capacitor holds the data voltage transferred to the pixel electrode for a predetermined time until a next data voltage is supplied. A common voltage is supplied to a common electrode opposite the pixel electrode. The display panel 10 may be implemented in any liquid crystal mode as well as the TN, VA, IPS, and FFS modes.

The color filter substrate includes black matrixes and color filters. The common electrodes are formed on the color filter substrate in a vertical electric field driving manner, such as a twisted nematic (TN) mode and a vertical alignment (VA) mode. The common electrodes are formed on the TFT substrate along with the pixel electrodes in a horizontal electric field driving manner, such as an in-plane switching (IPS) mode and a fringe field switching (FFS) mode.

An upper polarizing plate 11a is attached to the color filter substrate of the display panel 10, and a lower polarizing plate 11b is attached to the TFT array substrate of the display panel 10. As shown in FIG. 4, a light transmission axis r1 of the upper polarizing plate 11a is perpendicular to a light transmission axis r2 of the lower polarizing plate 11b. Alignment layers for setting pre-tilt angles of liquid crystals are respectively formed on the TFT substrate and the color filter substrate of the display panel 10. A spacer is formed between the TFT substrate and the color filter substrate of the display panel 10 so as to provide a cell gap of the liquid crystal layer.

The display panel 10 displays a two-dimensional (2D) image on odd-numbered lines and even-numbered lines thereof in a 2D mode. The display panel 10 displays a left eye image (or a right eye image) on the odd-numbered lines and displays a right eye image (or a left eye image) on the even-numbered lines in a three-dimensional (3D) mode. Light of the image displayed on the display panel 10 enters a patterned retarder 30 positioned on the display panel 10 through an upper polarizing film.

First retarders 31 are formed on odd-numbered lines of the patterned retarder 30, and second retarders 32 are formed on even-numbered lines of the patterned retarder 30. The first retarders 31 retard a phase value of light from the display panel 10 by +λ/4, where λ is a wavelength of light. The second retarders 32 retard a phase value of the light from the display panel 10 by −λ/4. An optical axis r3 of the first retarder 31 is perpendicular to an optical axis r4 of the second retarder 32. The first retarders 31 may be configured so as to pass through only a first circular polarization (for example, a left circular polarization), and the second retarders 32 may be configured so as to pass through only a second circular polarization (for example, a right circular polarization).

The patterned retarder 30 may include a black stripe for widening an vertical viewing angle. Instead of the patterned retarder 30, pixels of the display panel 10 may be controlled using an active black stripe.

A left eye polarization filter of the polarization glasses 20 has the same optical axis as the first retarder 31 of the patterned retarder 30, and a right eye polarization filter of the polarization glasses 20 has the same optical axis as the second retarder 32 of the patterned retarder 30. For example, a left circular polarization filter may be selected as the left eye polarization filter of the polarization glasses 20, and a right circular polarization filter may be selected as the right eye polarization filter of the polarization glasses 20. A user has to wear the polarization glasses 20 when viewing a 3D image, and has to remove the polarization glasses 20 when viewing a 2D image.

The data driver 120 includes a plurality of source driver integrated circuits (ICs). The source driver ICs convert image data RGB received from the timing controller 130 into positive and negative gamma compensation voltages and generate positive and negative analog data voltages. The source driver ICs then supply the positive and negative analog data voltages to the data lines D of the display panel 10.

The gate driver 110 includes a plurality of gate driver ICs. Each of the gate driver ICs includes a shift register, a level shifter, an output buffer, and the like. A level shifter converts an output signal of the shift register into a swing width suitable for a TFT drive of the liquid crystal cell. The gate driver 110 sequentially supplies a gate pulse synchronized with the data voltage to the gate lines G of the display panel 10 under the control of the timing controller 130.

A hold type display element requiring a backlight unit may be selected as the display panel 10. The hold type display element may be generally implemented as a transmissive liquid crystal display panel modulating light from the backlight unit. The backlight unit includes a plurality of light sources, which are turned on based on a driving current supplied by a backlight unit driver, a light guide plate (or a diffusion plate), a plurality of optical sheets, and the like. The backlight unit may be implemented as one of an edge type backlight unit and a direct type backlight unit. The light sources of the backlight unit may be implemented as at least one of a hot cathode fluorescent lamp (HCFL), a cold cathode fluorescent lamp (CCFL), an external electrode fluorescent lamp (EEFL), and a light emitting diode (LED).

The backlight unit driver generates the driving current for turning on the light sources of the backlight unit. The backlight unit driver turns on or off the driving current supplied to the light sources under the control of the timing controller 130. The timing controller 130 outputs backlight control data, that adjusts a backlight luminance and a turn-on time of the light sources based on a global or local dimming signal DIM received from the host system 150, to the backlight unit driver in a serial peripheral interface (SPI) data format.

The timing controller 130 outputs a gate control signal for controlling the gate driver 110 to the gate driver 110 based on image data RGB′ modulated by the data modulation unit 140 and timing signals Vsync, Hsync, DE, and CLK. Further, the timing controller 130 outputs a data control signal for controlling the data driver 120 to the data driver 120 based on the modulated image data RGB′ and the timing signals Vsync, Hsync, DE, and CLK. The gate control signal includes a gate start pulse GSP, a gate shift clock GSC, a gate output enable GOE, and the like. The gate start pulse GSP controls a timing of a first gate pulse. The gate shift clock GSC shifts the gate start pulse GSP. The gate output enable signal GOE controls an output timing of the gate driver 110.

The data control signal includes a source start pulse SSP, a source sampling clock SSC, a polarity control signal POL, a source output enable SOE, and the like. The source start pulse SSP controls a data sampling start time of the data driver 120. The source sampling clock SSC controls a sampling operation of the data driver 120 based on a rising or falling edge thereof. If the image data RGB to be input to the data driver 120 is transferred based on a mini low voltage differential signaling (LVDS) interface standard, the source start pulse SSP and the source sampling clock SSC may be omitted. The polarity control signal POL inverts a polarity of the data voltage output by the data driver 120 every L horizontal periods, where L is a natural number. The source output enable signal SOE controls an output timing of the data driver 120.

The host system 150 supplies the image data RGB to the data modulation unit 140 through an interface such as an LVDS interface and a transition minimized differential signaling (TMDS) interface. Further, the host system 150 supplies the timing signals Vsync, Hsync, DE, and CLK and a mode signal MODE to the data modulation unit 140.

The data modulation unit 140 receives the image data RGB and the timing signals Vsync, Hsync, DE, and CLK from the host system 150. As pixel data of an (n−1)th line (or an (m+1)th line) of the image data RGB approaches a white gray level, where n is a natural number equal to or greater than 2 and m is a natural number, the data modulation unit 140 modulates pixel data of an nth line (or an mth line) of the image data RGB so that the pixel data of the nth line (or an mth line) approaches a black gray level, and outputs the modulated pixel data.

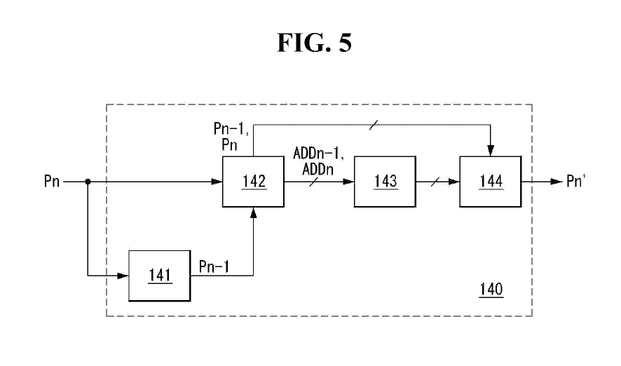

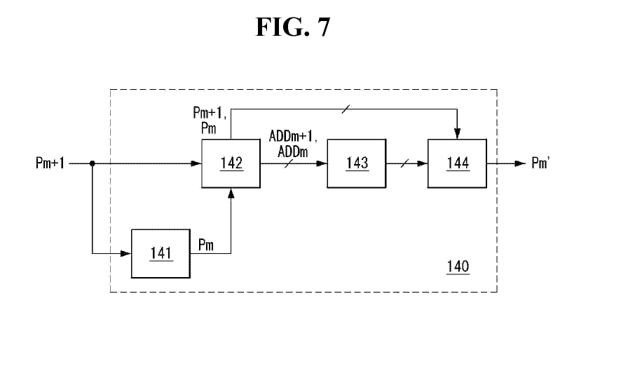

The timing signals Vsync, Hsync, DE, and CLK supplied by the host system 150 are converted in conformity with the timing of the image data RGB′ modulated by the data modulation unit 140. The modulated image data RGB′ and the timing signals Vsync, Hsync, DE, and CLK are input to the timing controller 130. The data modulation unit 140 is described in detail later with reference to FIGS. 5 and 7.

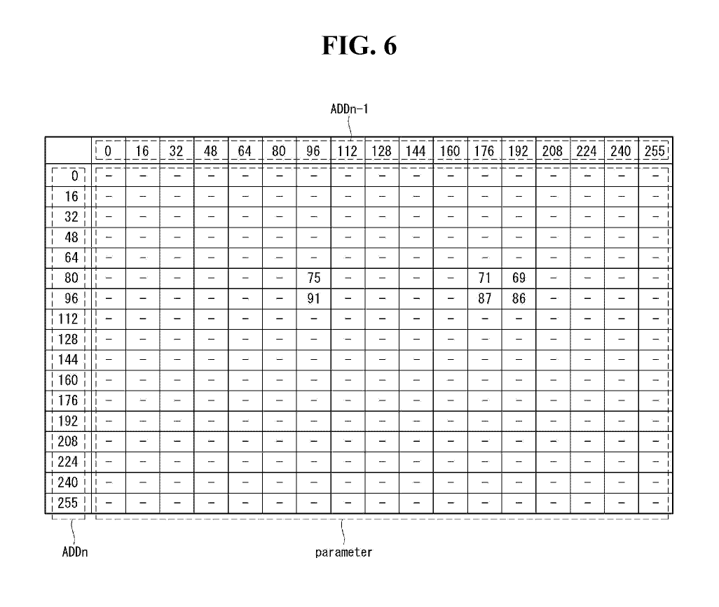

FIG. 5 is a block diagram illustrating a first exemplary configuration of the data modulation unit 140. FIG. 6 illustrates an exemplary lookup table shown in FIG. 5. The lookup table shown in FIG. 6 illustrates some of modulation parameters.

As shown in FIGS. 5 and 6, the data modulation unit 140 includes a memory 141, an input address calculating unit 142, a lookup table 143, and an interpolation unit 144. As pixel data Pn−1 of the (n−1)th line of the image data RGB approaches the white gray level, the data modulation unit 140 modulates pixel data Pn of the nth line of the image data RGB so that the pixel data Pn of the nth line approaches the black gray level, and outputs the modulated pixel data.

The memory 141 stores the pixel data Pn−1 of the (n−1)th line of the image data RGB. The memory 141 outputs the pixel data Pn−1 of the (n−1)th line to the input address calculating unit 142 in synchronization with the pixel data Pn of the nth line input to the input address calculating unit 142. In the embodiment of the invention, the pixel data is 8-bit pixel data as an example, and the 8-bit pixel data is represented by a data value of 0-255. Further, in the embodiment of the invention, the data value ‘255’ corresponds to the white gray level and the data value ‘0’ corresponds to the black gray level.

The input address calculating unit 142 receives the pixel data Pn−1 of the (n−1)th line and the pixel data Pn of the nth line. The input address calculating unit 142 calculates an input address ADDn−1 of the (n−1)th line and an input address ADDn of the nth line, and outputs the calculated input addresses ADDn−1 and ADDn to the lookup table 143. The lookup table 143 outputs modulation parameters stored at crossings between the input addresses ADDn−1 and ADDn to the interpolation unit 144.

In the lookup table 143 shown in FIG. 6, data on uppermost side of column lines is the input address ADDn−1 of the (n−1)th line, and data on the left side of row lines is the input address ADDn of the nth line. The lookup table 143 includes the modulation parameters output based on the input address ADDn−1 of the (n−1)th line and the input address ADDn of the nth line.

As shown in FIG. 6, the input addresses ADDn31 1 and ADDn of the lookup table 143 include a portion of data having the data value of 0-255. For example, the input address calculating unit 142 calculates two input addresses ADDn−1 of the (n−1)th line closest to the pixel data Pn−1 of the (n−1)th line and two input addresses ADDn of the nth line closest to the pixel data Pn of the nth line. The input address calculating unit 142 outputs the two input addresses ADDn−1 and the two input addresses ADDn to the lookup table 143. The lookup table 143 outputs four modulation parameters stored at four crossings between the two input addresses ADDn−1 of the (n−1)th line and the two input addresses ADDn of the nth line to the interpolation unit 144.

For example, when the pixel data Pn−1 of the (n−1)th line input to the input address calculating unit 142 is ‘179’ and the pixel data Pn of the nth line input to the input address calculating unit 142 is ‘83’, the input address calculating unit 142 calculates ‘176’ and ‘192’ as the two input addresses ADDn−1 of the (n−1)th line and calculates ‘80’ and ‘96’ as the two input addresses ADDn of the nth line. The lookup table 143 outputs four modulation parameters ‘71’, ‘69’, ‘87’, and ‘86’ stored at four crossings between the two input addresses ‘176’ and ‘192’ of the (n−1)th line and the two input addresses ‘80’ and ‘96’ of the nth line to the interpolation unit 144.

The interpolation unit 144 receives the modulation parameters from the lookup table 143 and receives the pixel data Pn−1 of the (n−1)th line and the pixel data Pn of the nth line from the input address calculating unit 142. The interpolation unit 144 outputs modulated pixel data Pn′ of the nth line from the pixel data Pn−1 of the (n−1)th line, the pixel data Pn of the nth line, and the modulation parameters using various known linear interpolation methods.

Also, the input addresses ADDn−1 of the (n−1)th line and the input addresses ADDn of the nth line in the lookup table 143 may include all of data values between 0 and 255.When the input addresses ADDn−1 of the (n−1)th line and the input addresses ADDn of the nth line in the lookup table 143 include all of data values between 0 and 255, the input address calculating unit 142 and the interpolation unit 144 may be omitted. In this instance, the lookup table 143 may directly receive the pixel data Pn−1 of the (n−1)th line and the pixel data Pn of the nth line as the input address and may output data stored at crossings between the input address ADDn−1 of the (n−1)th line and the input address ADDn of the nth line as the modulated pixel data Pn′ of the nth line.

Further, the data modulation unit 140 decides whether the input image data RGB is the 2D image data or the 3D image data. Only when the input image data RGB is the 3D image data, the data modulation unit 140 may be designed to modulate the image data RGB.

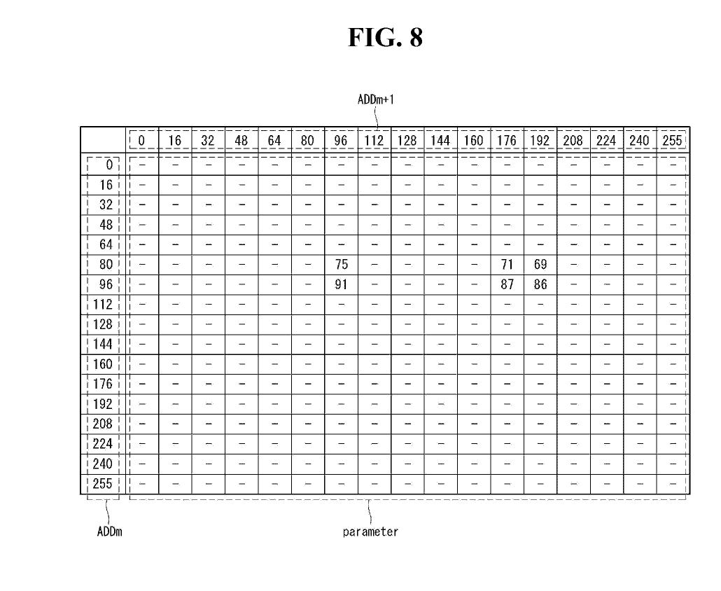

FIG. 7 is a block diagram illustrating a second exemplary configuration of the data modulation unit 140. FIG. 8 illustrates an exemplary lookup table shown in FIG. 7. The lookup table shown in FIG. 8 illustrates some of modulation parameters.

As shown in FIGS. 7 and 8, the data modulation unit 140 includes a memory 141, an input address calculating unit 142, a lookup table 143, and an interpolation unit 144. As pixel data Pm+1 of the (m+1)th line of the image data RGB approaches the white gray level, the data modulation unit 140 modulates pixel data Pm of the mth line of the image data RGB so that the pixel data Pm of the mth line approaches the black gray level, and outputs the modulated pixel data.

The memory 141 stores the pixel data Pm of the mth line of the image data RGB. The memory 141 outputs the pixel data Pm of the mth line to the input address calculating unit 142 in synchronization with the pixel data Pm+1 of the (m+1)th line input to the input address calculating unit 142. In the embodiment of the invention, the pixel data is 8-bit pixel data as an example, and the 8-bit pixel data is represented by a data value of 0-255. Further, in the embodiment of the invention, the data value ‘255’ corresponds to the white gray level and the data value ‘0’ corresponds to the black gray level.

The input address calculating unit 142 receives the pixel data Pm of the mth line and the pixel data Pm+1 of the (m+1)th line. The input address calculating unit 142 calculates an input address ADDm of the mth line and an input address ADDm+1 of the (m+1)th line, and outputs the calculated input addresses ADDm and ADDm+1 to the lookup table 143. The lookup table 143 outputs modulation parameters stored at crossings between the input addresses ADDm and ADDm+1 to the interpolation unit 144.

In the lookup table 143 shown in FIG. 8, data on uppermost side of column lines is the input address ADDm+1 of the (m+1)th line, and data on the left side of row lines is the input address ADDm of the mth line. The lookup table 143 includes the modulation parameters output based on the input address ADDm of the mth line and the input address ADDm+1 of the (m+1)th line.

As shown in FIG. 8, the input addresses ADDm and ADDm+1 of the lookup table 143 include a portion of data having the data value of 0-255. For example, the input address calculating unit 142 calculates two input addresses ADDm+1 of the (m+1)th line closest to the pixel data Pm+1 of the (m+1)th line and two input addresses ADDm of the mth line closest to the pixel data Pm of the mth line. The input address calculating unit 142 outputs the two input addresses ADDm+1 and the two input addresses ADDm to the lookup table 143. The lookup table 143 outputs four modulation parameters stored at four crossings between the two input addresses ADDm+1 of the (m+1)th line and the two input addresses ADDm of the mth line to the interpolation unit 144.

For example, when the pixel data Pm+1 of the (m+1)th line input to the input address calculating unit 142 is ‘179’ and the pixel data Pm of the mth line input to the input address calculating unit 142 is ‘83’, the input address calculating unit 142 calculates ‘176’ and ‘192’ as the two input addresses ADDm+1 of the (m+1)th line and calculates ‘80’ and ‘96’ as the two input addresses ADDm of the mth line. The lookup table 143 outputs four modulation parameters ‘71’, ‘69’, ‘87’, and ‘86’ stored at four crossings between the two input addresses ‘176’ and ‘192’ of the (m+1)th line and the two input addresses ‘80’ and ‘96’ of the mth line to the interpolation unit 144.

The interpolation unit 144 receives the modulation parameters from the lookup table 143 and receives the pixel data Pm of the mth line and the pixel data Pm+1 of the (m+1)th line from the input address calculating unit 142. The interpolation unit 144 output modulated pixel data Pm′ of the mth line from the pixel data Pm of the mth line, the pixel data Pm+1 of the (m+1)th line, and the modulation parameters using various known linear interpolation methods.

Also, the input addresses ADDm+1 of the (m+1)th line and the input addresses ADDm of the mth line in the lookup table 143 may include all of data values between 0 and 255. When the input addresses ADDm+1 of the (m+1)th line and the input addresses ADDm of the mth line in the lookup table 143 include all of data values between 0 and 255, the input address calculating unit 142 and the interpolation unit 144 may be omitted. In this instance, the lookup table 143 may directly receive the pixel data Pm+1 of the (m+1)th line and the pixel data Pm of the mth line as the input address and may output data stored at crossings between the input address ADDm+1 of the (m+1)th line and the input address ADDm of the mth line as the modulated pixel data Pm′ of the mth line.

Further, the data modulation unit 140 decides whether the input image data RGB is the 2D image data or the 3D image data. Only when the input image data RGB is the 3D image data, the data modulation unit 140 may be designed to modulate the image data RGB.

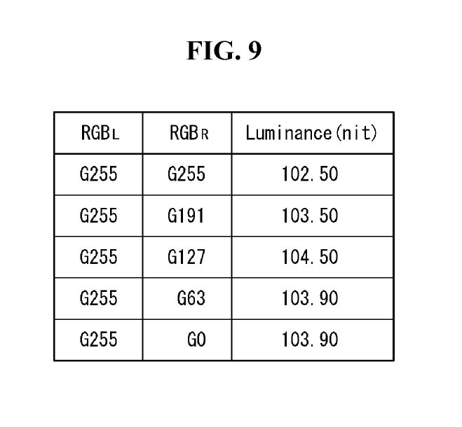

FIG. 9 is a table illustrating a luminance of the patterned retarder type stereoscopic image display according to the example embodiment of the invention. As shown in FIG. 9, a luminance of the left eye image input to the left eye polarization filter of the polarization glasses 20 was measured by supplying left eye image data RGB_{L} having a white gray level G255 and then supplying right eye image data RGB_{R} having the white gray level G255, grey gray levels G191, G127, and G63, and a black gray level G0. In the following description, the data modulation unit 140 shown in FIGS. 5 and 6 is used as an example.

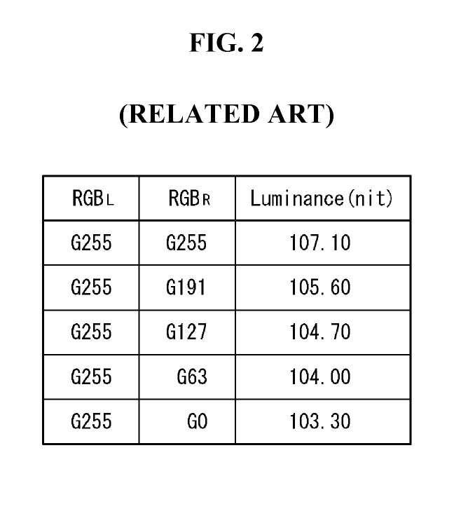

In the patterned retarder type stereoscopic image display according to the embodiment of the invention, because the left eye polarization filter of the polarization glasses 20 passes through only the left eye image, the luminance of the left eye image passing through the left eye polarization filter of the polarization glasses 20 is almost uniform irrespective of the right eye image. However, in the related art shown in FIG. 2, the luminance of the left eye image passing through the left eye polarization filter of the polarization glasses PG increased as the gray level of the right eye image data RGB_{R} increased. Namely, the luminance of the left eye image is affected by the gray level of the right eye image.

In other words, in the related art patterned retarder type stereoscopic image display shown in FIG. 2, as the pixel data Pn−1 of the (n−1)th line increases, the pixel data Pn of the nth line increases. Accordingly, in the patterned retarder type stereoscopic image display according to the embodiment of the invention, as the pixel data Pn−1 of the (n−1)th line approaches the white gray level G255, the data modulation unit 140 shown in FIG. 5 modulates the pixel data Pn of the nth line so that the pixel data Pn of the nth line approaches the black gray level G0, and outputs the modulated pixel data Pn′. Further, the lookup table 143 shown in FIG. 6 is designed, so that as the value of the input address ADDn−1 of the (n−1)th line increases, the value of the modulation parameter used as a reference to output the modulated pixel data Pn′ of the nth line decreases. For example, in the lookup table 143 shown in FIG. 6, when the input address ADDn−1 of the (n−1)th line is ‘96’, ‘176’, and ‘192’ and the input address ADDn of the nth line is ‘80’ and ‘96’, the modulation parameter has a maximum value at the input address ‘96’ of the (n−1)th line and the modulation parameter has a minimum value at the input address ‘192’ of the (n−1)th line.

In other words, in the patterned retarder type stereoscopic image display according to the embodiment of the invention, as shown in FIG. 9, the luminance of the left eye image passing through the left eye polarization filter of the polarization glasses 20 is almost uniform irrespective of the gray level of the right eye image. Accordingly, because the luminance of the left eye image passing through the left eye polarization filter of the polarization glasses 20 is affected by a luminance of the right eye image, the 3D crosstalk may be reduced.

FIG. 9 illustrated the luminance of the patterned retarder type stereoscopic image display according to the embodiment of the invention using the data modulation unit 140 shown in FIGS. 5 and 6. Additionally, the luminance of the patterned retarder type stereoscopic image display according to the embodiment of the invention may be described by using the data modulation unit 140 shown in FIGS. 7 and 8 in the same manner as the data modulation unit 140 shown in FIGS. 5 and 6.

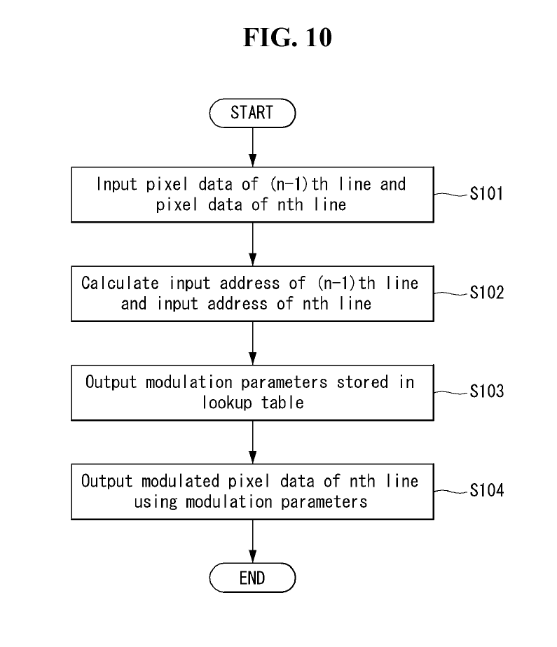

FIG. 10 is a flow chart sequentially illustrating a method for driving the stereoscopic image display according to the example embodiment of the invention. In the following description, the data modulation unit 140 shown in FIGS. 5 and 6 is used as an example.

As shown in FIG. 10, the pixel data Pn−1 of the (n−1)th line and the pixel data Pn of the nth line are input to the input address calculating unit 142 of the data modulation unit 140 in step S101. Further, in step S101, the memory 141 stores the pixel data Pn−1 of the (n−1)th line and outputs the pixel data Pn−1 of the (n−1)th line to the input address calculating unit 142 in synchronization with the pixel data Pn of the nth line input to the input address calculating unit 142.

The input address calculating unit 142 calculates the input address ADDn−1 of the (n−1)th line from the pixel data Pn−1 of the (n−1)th line and calculates the input address ADDn of the nth line from the pixel data Pn of the nth line input in step S102. A method for calculating the input address ADDn−1 of the (n−1)th line and the input address ADDn of the nth line was described above with reference to FIG. 6.

The lookup table 143 receives the input address ADDn−1 of the (n−1)th line and the input address ADDn of the nth line from the input address calculating unit 142 in step S103. Further, in step S103, the lookup table 143 outputs the modulation parameters stored at crossings between the input address ADDn−1 of the (n−1)th line and the input address ADDn of the nth line to the interpolation unit 144.

The interpolation unit 144 outputs the modulated pixel data Pn′ of the nth line from the pixel data Pn−1 of the (n−1)th line and the pixel data Pn of the nth line output by the input address calculating unit 142, and the modulation parameters output by the lookup table 143 in step S104. The interpolation unit 144 may output the modulated pixel data Pn′ of the nth line using various known linear interpolation methods.

FIG. 10 illustrated the method for driving the stereoscopic image display according to the embodiment of the invention using the data modulation unit 140 shown in FIGS. 5 and 6. Additionally, the driving method of the stereoscopic image display according to the embodiment of the invention may be described by using the data modulation unit 140 shown in FIGS. 7 and 8 in the same manner as the data modulation unit 140 shown in FIGS. 5 and 6.

As described above, in the stereoscopic image display according to the embodiment of the invention, as the pixel data of the (n−1)th line (or the (m+1)th line) of the image data approaches the white gray level, the pixel data of the nth line (or the mth line) is modulated so that the pixel data of the nth line approaches the black gray level. Hence, the luminance of the left eye image passing through the left eye polarization filter of the polarization glasses is little affected by the luminance of the right eye image. Further, the luminance of the right eye image passing through the right eye polarization filter of the polarization glasses is little affected by the luminance of the left eye image in the same manner as the left eye image. As a result, the 3D crosstalk may be reduced, and the user may view the stereoscopic image more stereoscopically.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A stereoscopic image display comprising:
a display panel including data lines and gate lines crossing the data lines;
a data modulation unit configured to modulate input image data so that pixel data of an nth line of the image data approaches a black gray level as pixel data of an (n−1)th line of the image data approaches a white gray level, where n is a natural number equal to or greater than 2;
a data driver configured to convert the image data modulated by the data modulation unit into a data voltage and output the data voltage to the data lines; and
a gate driver configured to sequentially output a gate pulse synchronized with the data voltage to the gate lines.

2. The stereoscopic image display of claim 1, wherein the data modulation unit includes:
an input address calculating unit configured to receive the pixel data of the (n−1)th line and the pixel data of the nth line, calculate an input address of the (n−1)th line from the pixel data of the (n−1)th line, and calculate an input address of the nth line from the pixel data of the nth line;
a lookup table configured to output a modulation parameter positioned at a crossing between the input address of the (n−1)th line and the input address of the nth line calculated by the input address calculating unit;
an interpolation unit configured to output modulated pixel data of the nth line from the pixel data of the (n−1)th line, the pixel data of the nth line, and the modulation parameter; and
a memory configured to store the pixel data of the (n−1)th line and output the pixel data of the (n−1)th line to the input address calculating unit in synchronization with the pixel data of the nth line.

3. The stereoscopic image display of claim 2, wherein as a value of the input address of the (n−1)th line increases, the lookup table outputs a reduced modulation parameter.

4. The stereoscopic image display of claim 1, wherein the data modulation unit includes:
a lookup table configured to receive the pixel data of the (n−1)th line as an input address of the (n−1)th line, receive the pixel data of the nth line as an input address of the nth line, and output modulated pixel data positioned at a crossing between the input address of the (n−1)th line and the input address of the nth line; and
a memory configured to store the pixel data of the (n−1)th line and output the pixel data of the (n−1)th line to the lookup table in synchronization with the pixel data of the nth line.

5. The stereoscopic image display of claim 4, wherein as a value of the input address of the (n−1)th line increases, the lookup table outputs reduced modulated pixel data.

6. A stereoscopic image display comprising:
a display panel including data lines and gate lines crossing the data lines;
a data modulation unit configured to modulate input image data so that pixel data of an mth line of the image data approaches a black gray level as pixel data of an (m+1)th line of the image data approaches a white gray level, where m is a natural number;
a data driver configured to convert the image data modulated by the data modulation unit into a data voltage and output the data voltage to the data lines; and
a gate driver configured to sequentially output a gate pulse synchronized with the data voltage to the gate lines.

7. The stereoscopic image display of claim 6, wherein the data modulation unit includes:
an input address calculating unit configured to receive the pixel data of the (m+1)th line and the pixel data of the mth line, calculate an input address of the (m+1)th line from the pixel data of the (m+1)th line, and calculate an input address of the mth line from the pixel data of the mth line;
a lookup table configured to output a modulation parameter positioned at a crossing between the input address of the (m+1)th line and the input address of the mth line calculated by the input address calculating unit;
an interpolation unit configured to output modulated pixel data of the mth line from the pixel data of the (m+1)th line, the pixel data of the mth line, and the modulation parameter; and
a memory configured to store the pixel data of the (m+1)th line and output the pixel data of the (m+1)th line to the input address calculating unit in synchronization with the pixel data of the mth line.

8. The stereoscopic image display of claim 7, wherein as a value of the input address of the (m+1)th line increases, the lookup table outputs a reduced modulation parameter.

9. The stereoscopic image display of claim 6, wherein the data modulation unit includes:
a lookup table configured to receive the pixel data of the (m+1)th line as an input address of the (m+1)th line, receive the pixel data of the mth line as an input address of the mth line, and output modulated pixel data positioned at a crossing between the input address of the (m+1)th line and the input address of the mth line; and
a memory configured to store the pixel data of the (m+1)th line and output the pixel data of the (m+1)th line to the lookup table in synchronization with the pixel data of the mth line.

10. The stereoscopic image display of claim 9, wherein as a value of the input address of the (m+1)th line increases, the lookup table outputs reduced modulated pixel data.

11. A method for driving a stereoscopic image display including a display panel including data lines and gate lines crossing the data lines, the method comprising:
modulating input image data so that pixel data of an nth line of the image data approaches a black gray level as pixel data of an (n−1)th line of the image data approaches a white gray level, where n is a natural number equal to or greater than 2;
converting the modulated image data into a data voltage and outputting the data voltage to the data lines; and
sequentially outputting a gate pulse synchronized with the data voltage to the gate lines.

12. The method of claim 11, wherein the modulating of the input image data includes:
storing the pixel data of the (n−1)th line and outputting the pixel data of the (n−1)th line in synchronization with the pixel data of the nth line;
receiving the pixel data of the (n−1)th line and the pixel data of the nth line, calculating an input address of the (n−1)th line from the pixel data of the (n−1)th line, and calculating an input address of the nth line from the pixel data of the nth line;
outputting a modulation parameter positioned at a crossing between the input address of the (n−1)th line and the input address of the nth line; and
outputting modulated pixel data of the nth line from the pixel data of the (n−1)th line, the pixel data of the nth line, and the modulation parameter.

13. The method of claim 12, wherein the outputting of the modulation parameter includes outputting a reduced modulation parameter as a value of the input address of the (n−1)th line increases.

14. The method of claim 11, wherein the modulating of the input image data includes:
storing the pixel data of the (n−1)th line and outputting the pixel data of the (n−1)th line in synchronization with the pixel data of the nth line; and
receiving the pixel data of the (n−1)th line as an input address of the (n−1)th line, receiving the pixel data of the nth line as an input address of the nth line, and outputting modulated pixel data positioned at a crossing between the input address of the (n−1)th line and the input address of the nth line.

15. The method of claim 14, wherein the outputting of the modulated pixel data includes outputting reduced modulated pixel data as a value of the input address of the (n−1)th line increases.

16. A method for driving a stereoscopic image display including a display panel including data lines and gate lines crossing the data lines, the method comprising:
modulating input image data so that pixel data of an mth line of the image data approaches a black gray level as pixel data of an (m+1)th line of the image data approaches a white gray level, where m is a natural number;
converting the modulated image data into a data voltage and outputting the data voltage to the data lines; and
sequentially outputting a gate pulse synchronized with the data voltage to the gate lines.

17. The method of claim 16, wherein the modulating of the input image data includes:
storing the pixel data of the (m+1)th line and outputting the pixel data of the (m+1)th line in synchronization with the pixel data of the mth line;
receiving the pixel data of the (m+1)th line and the pixel data of the mth line, calculating an input address of the (m+1)th line from the pixel data of the (m+1)th line, and calculating an input address of the mth line from the pixel data of the mth line;
outputting a modulation parameter positioned at a crossing between the input address of the (m+1)th line and the input address of the mth line; and
outputting modulated pixel data of the mth line from the pixel data of the (m+1)th line, the pixel data of the mth line, and the modulation parameter.

18. The method of claim 17, wherein the outputting of the modulation parameter includes outputting a reduced modulation parameter as a value of the input address of the (m+1)th line increases.

19. The method of claim 16, wherein the modulating of the input image data includes:
storing the pixel data of the (m+1)th line and outputting the pixel data of the (m+1)th line in synchronization with the pixel data of the mth line; and
receiving the pixel data of the (m+1)th line as an input address of the (m+1)th line, receiving the pixel data of the mth line as an input address of the mth line, and outputting modulated pixel data positioned at a crossing between the input address of the (m+1)th line and the input address of the mth line.

20. The method of claim 19, wherein the outputting of the modulated pixel data includes outputting reduced modulated pixel data as a value of the input address of the (m+1)th line increases.
